(19) United States
(12) Patent Application Publication
(10) Pub. No.: US 2025/0380114 A1
(43) Pub. Date: Dec. 11, 2025

(54) TRANSMITTING DEVICE, GROUP PROCESSING METHOD AND GROUP PROCESSING SYSTEM

(71) Applicant: BRILLIANT SILICON LIMITED, Aberdeen (HK)

(72) Inventors: CHUN-LUNG CHEN, Hsinchu City (TW); I-FENG SU, Hsinchu City (TW); CHI-HSUEH WANG, Hsinchu City (TW)

(21) Appl. No.: 19/229,820

(22) Filed: Jun. 5, 2025

Related U.S. Application Data
(60) Provisional application No. 63/658,654, filed on Jun. 11, 2024.

(30) Foreign Application Priority Data
Dec. 30, 2024 (TW) 113151453

(51) Int. Cl. H04W 4/08; H04W 16/18

(52) U.S. Cl. CPC H04W 4/08; H04W 16/18

(57) ABSTRACT

A group processing system for a venue, includes: a plurality of transmitting devices, each having: a transmitter configured to transmit a group formation command; and a command coverage area being an area within the venue where commands transmitted by the transmitter can be received. The command coverage area decides an operation range of a group member in the venue. The group formation command enables the at least one receiving device within the command coverage area to form and/or be identified as a same group. The group formation command enables to form and/or be identified a group within the command coverage area which is different from a group of a different receiving device within another command coverage area.

### CROSS-REFERENCE TO RELATED INVENTION

This patent application claims the benefit of U.S. Provisional Application No. 63/658,654 filed on Jun. 11, 2024 and claims priority from Taiwan Patent Application No. 113151453 filed on Dec. 30, 2024, which are hereby incorporated herein by reference in its entirety.

### FIELD OF INVENTION

The embodiments of the present disclosure relate to a device, a method, and a system for group processing.

### BACKGROUND

Currently, live performances, events, and parties are often held in various types of venues, for example, concerts and performances in stadiums, performance halls, outdoor plazas, large spaces, etc. During live performances, events or parties, items like glow sticks and wristbands are often distributed to enhance the entertainment effect and interaction. However, the preparation of these items is often complex and time-consuming, requiring significant human resources. Additionally, the entertainment effect is limited by the inherent capabilities of the items. If there were devices, methods, and systems for group processing that could be regionally targeted and easily implemented at live performances or events, it would greatly enhance the experience of live performances, events or parties.

### SUMMARY

The embodiments of the present disclosure provide a transmitting device for a group processing for at least one receiving device within a venue, comprising: a transmitter configured to transmit a group formation command; and a command coverage area being an area within the venue where commands transmitted by the transmitter can be received, wherein the command coverage area decides an operation range of a group member in the venue, wherein the group formation command enables the at least one receiving device within the command coverage area to form and/or be identified as a same group.

The embodiments of the present disclosure provide a group processing method for a receiving device within a venue, comprising: at the situation that the receiving device enters a command coverage area of one of a plurality of transmitting devices in the venue, the receiving device receiving a group formation command from the one of the transmitting devices; and according to the group formation command, the receiving device and another receiving device within the command coverage area forming and/or being identified as a same group, wherein, the command coverage area of the one of the transmitting devices decides an operation range of a group member in the venue.

The embodiments of the present disclosure provide a group processing system for a venue, comprising: a plurality of transmitting devices, each comprising: a transmitter configured to transmit a group formation command; and a command coverage area being an area within the venue where commands transmitted by the transmitter can be received, wherein the command coverage area decides an operation range of a group member in the venue, wherein the group formation command enables the at least one receiving device within the command coverage area to form and/or be identified as a same group, wherein the group formation command enables to form and/or be identified a group within the command coverage area which is different from a group of a different receiving device within another command coverage area.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-2 are schematic diagrams of a group processing system according to an embodiment.

FIG. 3 is a schematic diagram illustrating the process of forming a group according to an embodiment.

FIG. 4 is a schematic diagram illustrating the process of forming a group according to an embodiment.

FIG. 5 is a schematic diagram illustrating group control according to an embodiment.

FIG. 6 is a schematic diagram illustrating the operation of a signal relay station in a broadcasting system according to an embodiment.

FIG. 7 is a schematic diagram illustrating the operation of a plurality of signal relay stations in a broadcasting system according to an embodiment.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Various types of gatherings, such as live performances, events or parties are often held in various venues, including stadiums, arenas, sports fields, squares, streets, roads, performance halls, and event centers. Live performances, events or parties, etc. include concerts, music festivals, sporting events, athletic activities, and entertainment events, etc. The embodiments of the present disclosure relate to devices, methods, and systems for group processing in venues, which are regionally targeted and easily implemented at live performances or events, making them more exciting. They also feature a simplified structure, cost reduction, and ease of maintenance.

Items with visual, auditory, or tactile effects, such as glow sticks, wristbands, towels with specific colors or patterns, and clothing, can be provided to the audience, crowd, or participants at live performances, events, or gatherings to produce explicit behavior effects. Items with visual effects can include light-emitting elements, items with auditory effects can include speakers or sound-generating components, and items with tactile effects can include vibrators. These items can serve as receiving devices by including receivers, and using the disclosed transmitting device and/or group processing system, the receiving devices can exhibit explicit behaviors such as visual, auditory, or tactile effects. For example, visual effects might involve a plurality of receiving devices collectively presenting a pattern, such as text or a graphic. Visual effects might involve a screen of the receiving device displaying a pattern. For example, auditory effects could include the receiving devices which sound. For example, tactile effects could involve the receiving devices that generate vibrations. Additionally, mobile communication devices can serve as items with visual, auditory, and/or tactile effects as mentioned above. For example, a mobile communication device might have an application which is installed to communicate with the transmitting device and/or group processing system of the present disclosure, thereby exhibiting explicit behavior such as visual, auditory, or tactile effects.

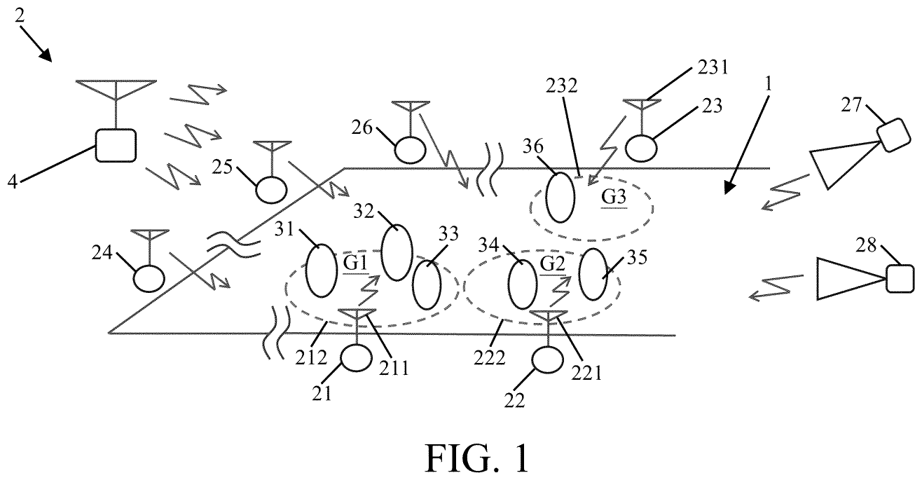

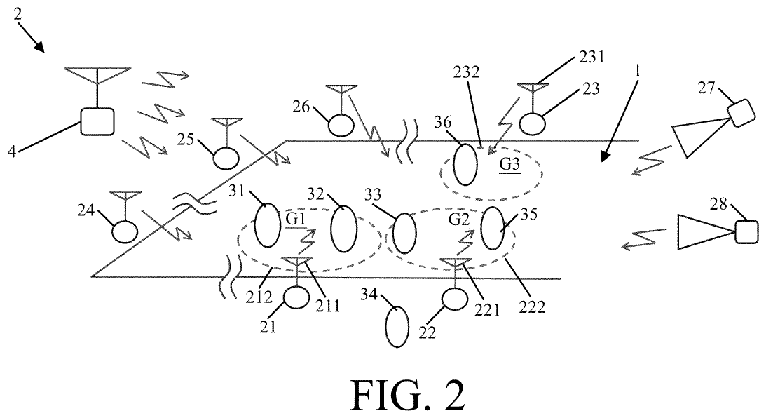

FIGS. 1-2 are schematic diagrams of a group processing system according to an embodiment. In FIG. 1, a group processing system 2 is used in a venue 1. The group processing system 2 includes a plurality of transmitting devices, such as transmitting devices 21-28. The number of transmitting devices depends on the size of the venue 1 or the complexity of the planning for live performance, event, or gathering. For medium to large scale live performances, events, or gatherings, the number of transmitting devices deployed in the venue can be in the hundreds or thousands or even more. Through these transmitting devices, group control of a large number of receiving devices can be achieved, but group pairing settings of the transmitting devices and the receiving devices are not required. Group settings for the receiving devices can be performed via the transmitting devices as the receiving devices are used within the venue 1.

The transmitting device 21 includes a transmitter 211 and a command coverage area 212. The transmitter 211 is configured to transmit a group formation command, and the command coverage area 212 is an area within the venue 1 where the commands transmitted by transmitter 211 can be received. The transmitting device 22 includes a transmitter 221 and a command coverage area 222. Transmitter 221 is configured to transmit a group formation command, and the command coverage area 222 is an area within the venue 1 where the commands transmitted by transmitter 221 can be received. The transmitting device 23 includes a transmitter 231 and a command coverage area 232. The transmitter 231 is configured to transmit a group formation command, and the command coverage area 232 is an area within the venue 1 where the commands transmitted by transmitter 231 can be received. Other transmitting devices 24-28 also have transmitters and command coverage areas, it is not repeated here. Additionally, the transmitting device may include a receiver to receive commands from other devices.

The command coverage area decides the operation range of group members in the venue 1. The group formation command enables at least one receiving device within the command coverage area to form and/or be identified as a same group. The command coverage area enables a leaving receiving device no longer to belong to the same group within the command coverage area. For example, the transmitter 211 transmits a group formation command that enables the receiving devices 31-33 within the command coverage area 212 to form and/or be identified as the same group G1. The operation range of the members of group G1 (i.e., receiving devices 31-33) is decided by the command coverage area 212. Members of group G1 operate within the command coverage area 212 according to the instructions of group G1. If a member of group G1 moves outside the command coverage area 212, it no longer operates according to the instructions of group G1. Namely, members of group G1 only operate within the command coverage area 212 according to the instructions of group G1. The same or similarly, the above implementation also applies to other transmitting devices and the receiving devices within their command coverage areas. For example, the transmitter 221 transmits a group formation command that enables the receiving devices 34-35 within the command coverage area 222 to form and/or be identified as group G2. The transmitter 231 transmits a group formation command that enables the receiving device 36 within the command coverage area 232 to form and/or be identified as group G3. Members of group G2 only operate according to the instructions of group G2 within the command coverage area 222, and members of group G3 only operate according to the instructions of group G3 within the command coverage area 232.

For example, the receiving device 33 in FIG. 1 is within the command coverage area 212 belonging to group G1. Then, as shown in FIG. 2, the receiving device 33 leaves the command coverage area 212 and thus no longer belongs to group G1 and cannot receive commands from transmitter 211. The receiving device 33 moves into the command coverage area 222, and the group formation command transmitted from transmitter 221 enables the receiving devices 33 and 35 within the command coverage area 222 to form and/or be identified as group G2. In some embodiments, when the receiving device leaves or enters the command coverage area, a notification mechanism may be triggered. The notification mechanism could be, for example, a sound, light, vibration, message, or instruction, etc. The prompt target can be the holder, wearer, or user of the receiving device. For example, after the receiving device 33 leaves the command coverage area (e.g., 212) of one of the transmitting devices (e.g., 21), the receiving device 33 removes its group identification and generates a prompt to represent that it has left the command coverage area (e.g., 212); at the situation that the receiving device 33 enters the command coverage area (e.g., 222) of one of the transmitting devices (e.g., 22) in the venue and before receiving a group formation command from any of the transmitting devices (e.g., 22), the receiving device 33 receives any signal from these transmitting devices (e.g., 22) and generates a prompt to represent that it has entered the command coverage area (e.g., 222).

Besides, in some embodiments, only the receiving devices that are in the waiting mode for grouping setup will form and/or be identified as a same group according to the group formation command. The receiving devices not in the waiting mode for grouping setup will not start or re-initiate group formation and/or identification. For example, even if the receiving device not in the waiting mode for grouping setup receives the group formation command, it will retain its original group identification or has no group identification.

In some embodiments, each transmitter is configured to transmit a group action command that enables the receiving devices within the command coverage area of each transmitter to perform corresponding actions with respect to each group. This allows each receiving device to operate according to the instructions of its belonging group, thereby exhibiting explicit behaviors such as visual, auditory, and/or tactile effects. The group action command is transmitted after the group has been formed, and the receiving device should act according to the group action command after the group has been formed. If the receiving device receives the group action command before it joins or forms the group, the receiving device still does not act according to the group action command. Additionally, the transmitting devices can also be grouped, for example, the transmitting devices 25 and 26 could belong to the same group, and transmitting devices 21-23 each belong to different groups. The command coverage areas of transmitting devices 25 and 26, which are in the same group, can overlap or not overlap. The receiving devices within the command coverage areas of transmitting devices 25 and 26 of the same group can form and/or be identified as a same group.

In some embodiments, the group formation command enables to form and/or be identified a group within the command coverage area which is different from a group of a different receiving device within another command coverage area. For example, the group formation command transmitted by the transmitter 221 of the transmitting device 21 enables to form and/or be identified a group G1 within the command coverage area 212 which is different from the receiving device 34-36 within the command coverage area 222, 232. In some embodiments, the command coverage area of the transmitting device can overlap another command coverage area of an operation range of another group members in the venue decided by another transmitting device. For example, the command coverage area 212 of the transmitting device 21 may overlap the command coverage areas 222, 232 of the transmitting devices 22, 23. The above implement manner is also applied to the transmitting devices 22, 23 and the receiving devices 34-36 within their command coverage area and the groups G2, G3. Thus, their description are not repeated here.

In some embodiments, the group formation command is a signal, light or sound. At the situation that the group formation command is implemented as a signal, the transmitting device can be a wireless communication device, such as a relay station, and the transmitter of the transmitting device transmits the command by broadcast; the transmitter can be a wireless signal transmitter, which may include a transmitter circuit and an antenna component, etc.; the command coverage area is the coverage range of the wireless signal; the receiving device may include active or passive wireless communication components to receive the wireless signal.

In some embodiments, the group processing system 2 further includes a command transmitting device 4, or one or more of the transmitting devices serve as command transmitting devices. The command transmitting device 4 is configured to define groups of the receiving devices and to transmit a group definition command to the transmitting devices 21-28, enabling each transmitter of the transmitting devices 21-28 to broadcast the group formation commands. The command transmitting device 4 may receive a command from a main control station through wire or wireless communication with the main control station.

In some embodiments, the command transmitting device 4 is configured to transmit commands to single one, or a single group, or a plurality of groups of the transmitting devices 21-28. One of the transmitting devices 21-28 transmits commands to a single receiving device, or a single group, or a plurality of groups according to the command transmitting device 4. Thereby, this allows for the command transmission and control for a single transmitting device, or a single receiving device, or a single group of receiving devices, or a single group of transmitting devices, or a single group of receiving device and transmitting device, or multiple groups of receiving devices, or multiple groups of transmitting devices, or multiple groups of receiving devices and transmitting devices.

In some embodiments, the transmitting devices 21-28 are relay stations. The transmitters of the transmitting devices 21-28 transmit commands by broadcasting. The commands, for example, are group formation commands or group action commands. The relay stations, for example, may broadcast the commands received from the command transmitting device 4 by relaying or forwarding. The command transmitting device 4 can communicate with the transmitting devices 21-28 through wireless and/or wired means. In some embodiments, the command transmitting device 4 can communicate wirelessly with the transmitting devices 21-28, allowing for easy large-scale deployment, configuration, and modification, especially in applications requiring a large number of devices, such as live performances, events, or gatherings. In some embodiments, the command transmitting device 4 may also communicate wirelessly with the receiving devices, for example, using a broadcast method.

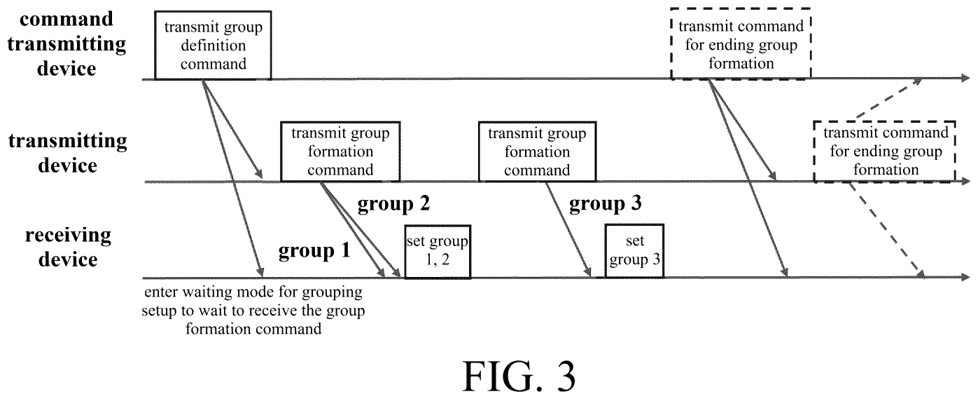

As shown in FIG. 3, the process of forming or joining a group by the receiving device may be initiated by the command transmitting device. First, the command transmitting device 4 transmits a group definition command to the transmitting devices and the receiving devices, e.g., all or some of the transmitting devices, all or some of the receiving devices, enabling these transmitting devices to enter a group definition mode to transmit the group formation command by the transmitter, and enabling these receiving devices to enter a waiting mode for grouping setup to wait to receive the group formation command from the transmitting devices. In some embodiments, the command transmitting device may periodically transmit the group formation command.

Before the receiving device receives the group formation command from the transmitting device owing the command coverage area in which the receiving device is located, the receiving device enters the waiting mode for grouping setup according to the group definition command from the command transmitting device to wait to receive the group formation command. The transmitting device is configured to enter the group definition mode according to the group definition command from the command transmitting device to enable the transmitter to transmit the group formation command, for example, by using signals, light, sound, etc. Upon receipt of the group formation command by receiving devices within the same command coverage area, these receiving devices form and/or are identified as the same group. For example, each receiving device receives the group formation command and is individually identified with group number accordingly.

In some embodiments, after these transmitting devices receive the group definition command, the transmitting devices may transmit the group formation commands for different groups to multiple receiving devices or designate a single device to set a specified group number. In some embodiments, after these transmitting devices receive the group definition command, they may sequentially form different groups at different times, or may form a small number of groups at the same time. For example, the transmitting devices of groups 1, 2 may first transmit the group formation command to the receiving devices for groups 1, 2 within the range of their command coverage areas, and then configure the receiving devices of groups 1, 2 to form and/or be identified as the same group. Then, the transmitting device of group 3 may first transmit the group formation command to the receiving devices for group 3 within the range of its command coverage areas, and then configure the receiving devices of group 3 within the command coverage areas to form and/or be identified as the same group.

The formation of a group may be ended after a period of group formation has elapsed, e.g., a period of a predefined length of time. In some embodiments, ending of group formation may be, for example: the command transmitting device 4 is configured to transmit a command for ending group formation to the transmitting devices and the receiving devices in order to indicate the end of the period for forming group, enabling the transmitting devices to end the group definition mode and the receiving devices to end the waiting mode for grouping setup. In some other embodiments, ending of group formation may be, the transmitting devices are configured to respectively transmit a command for ending group formation to the command transmitting device and the receiving devices, enabling the transmitting devices to end the group definition mode and the receiving devices to end the waiting mode for grouping setup. In some other embodiments, ending of group formation may be, the command transmitting device is configured to transmit a group action command to the transmitting devices and the receiving devices in order to indicate the start of group action which is not to form a group, enabling the transmitting devices to end the group definition mode and the receiving devices to end the waiting mode for grouping setup. Additionally, the receiving device can choose whether to send a signal to the command transmitting device or the transmitting device in response to the grouping status.

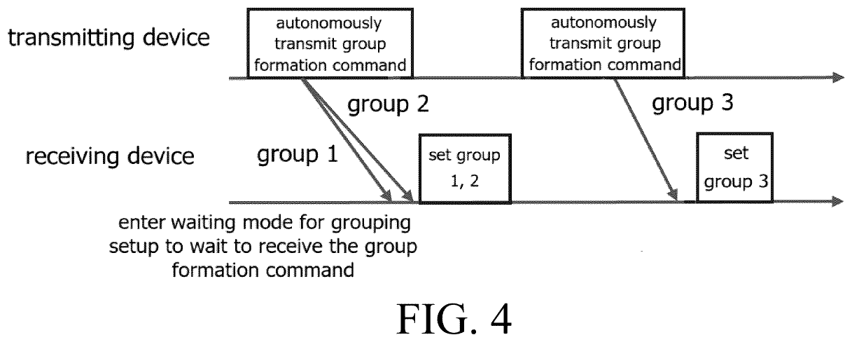

As shown in FIG. 4, the process of forming a group may be initiated by the transmitting device without the command transmitting device 4. The transmitting device may autonomously transmit the group formation command, and may transmit group formation commands for different groups to multiple receiving devices, and may designate a single device to set a specified group number. For example, a plurality of transmitter devices autonomously cause each transmitter to transmit the group formation command to the receiver device. The group formation process in FIG. 4 can be referred to FIG. 3 and will not be repeated here. In some embodiments, the transmitting device may periodically and autonomously transmit the group formation command.

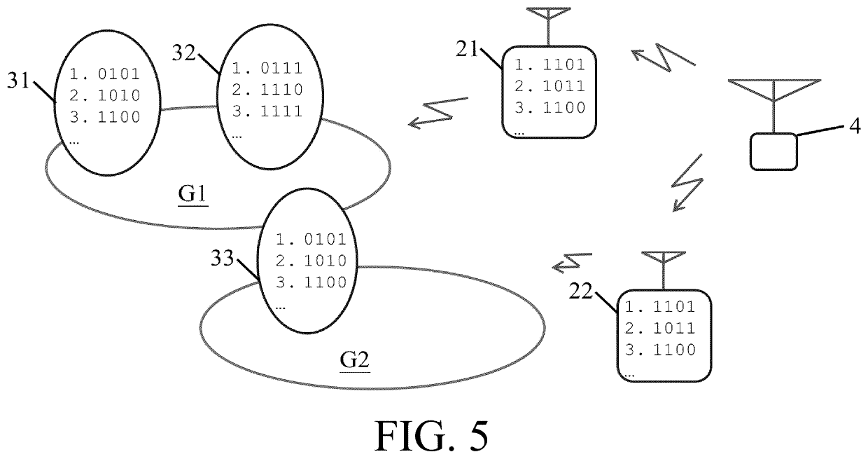

As shown in FIG. 5, the command transmitting device 4 can transmit a command with respect to a single group or multiple groups. The command transmitting device 4 can transmit same or different commands with respect to the receiving devices of different groups. For example, the command transmitting device 4 is configured to transmit a group action command and send the group action command through a plurality of the transmitting devices (e.g. 21, 22) to a plurality of the receiving devices (e.g. 31, 32, 33). The group action command enables the receiving device within the command coverage area to perform corresponding action. The group action command is a specific arranged command or a prearranged corresponding command. The specific arranged command is with respect to the same group to perform same action. The prearranged corresponding command is with respect to same group using same identifier to perform same or different action, and is with respect to different groups to perform same or different actions.

In some embodiments, the transmitter of the transmitting device can rewrite an internally prearranged corresponding action of the group action command from the command transmitting device with respect to single one receiving device or single one group or multiple groups. In some embodiments, the receiving device may rewrite an internally prearranged corresponding action of the group action command. In some embodiments, the command transmitting device 4 may rewrite an internally prearranged corresponding action of a command in the receiving device; alternatively, the command transmitting device 4 may rewrite an internally prearranged corresponding action of a command with respect to single one receiving device or single one group or multiple groups. This allows dynamic adjustment of the actions to be performed by the receiving device or group during operation, increasing the overall configurability.

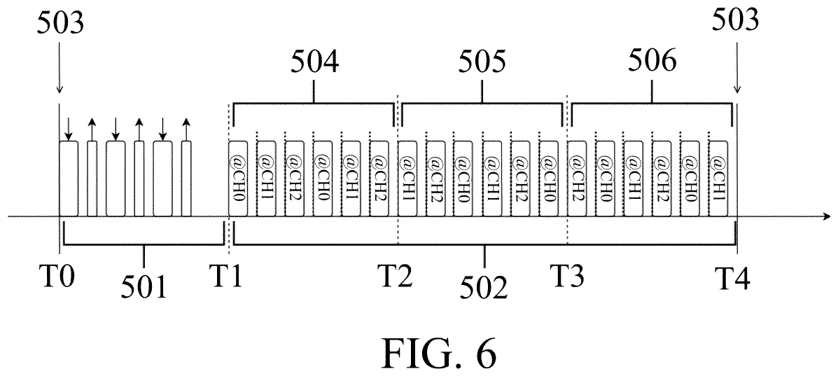

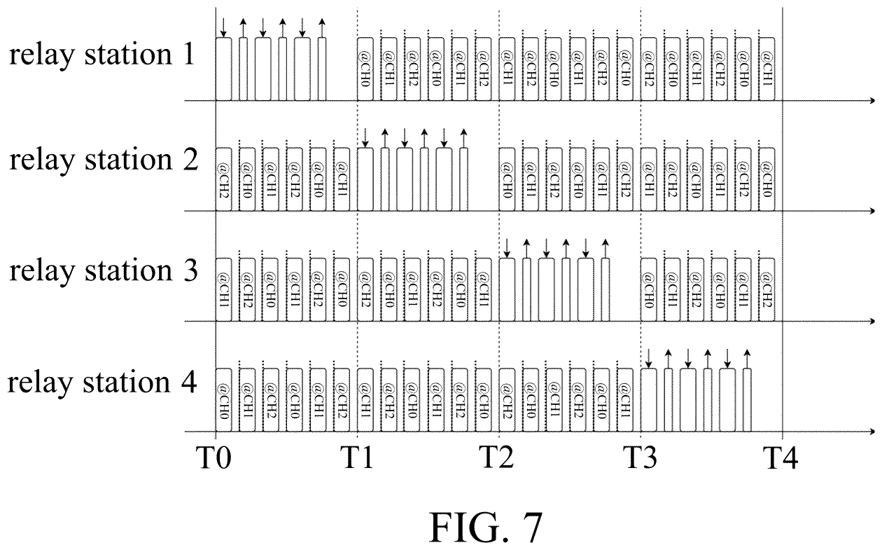

FIG. 6 is a schematic diagram illustrating the operation of a signal relay station in a broadcasting system according to an embodiment. FIG. 7 is a schematic diagram illustrating the operation of a plurality of signal relay stations according to an embodiment. The signal relay station may serve as the transmitting device of the foregoing embodiment. The signal source of the signal relay station can be the command transmitting device of the foregoing embodiment. The signal broadcasting target of the signal relay station can be the receiving device of the foregoing embodiment. Alternatively, one signal relay station may represent one transmitting device of the foregoing embodiment or multiple transmitting devices belonging to the same group. Alternatively, multiple signal relay stations may represent multiple transmitting devices belonging to the same group. These representations may vary depending on the actual requirements.

As shown in FIG. 6 and FIG. 7, the signal relay stations of the broadcasting system are used for group control of large gathering and can be synchronized with other signal relay stations to broadcast. A single transaction (503) performed by the signal relay station includes an action period 501 and an action period 502 following the action period 501. The action period 501 can be the connection period for communicating with the upper-level device (main transmitting device), and the communicating connection may be performed by unicast; the action period 502 can be the connection period for communicating with the lower-level devices (receiving devices), and the communicating connection may be performed by broadcast.

The signal relay station includes a receiver and a transmitter. The receiver is configured to receive to-be-broadcast data and output a correcting time signal during the action period 501. In some embodiments, after the main transmitting device establishes a connection with the receiver, the receiver outputs the correcting time signal to the transmitter. The correcting time signal is a synchronization signal that enables the transmitter to start broadcasting the to-be-broadcast data at a designated time. The signal relay station has a connection with the main transmitting device (or the command transmitting device) through the receiver and the transmitter during the action period 501 so as to receive the to-be-broadcast data, and the connection manner may be unicast rather than broadcast. The main transmitting device (or the command transmitting device) can send information of control station such as commands, etc. to the receiver of the signal relay station by using unicast. In some embodiments, a start time and a length of the action period 501 are allocated and regulated by the main transmitting device when establishing the connection with the receiver, and the main transmitting device may retransmit the to-be-broadcast data multiple times during the action period 501.

The transmitter is configured to receive the to-be-broadcast data and the correcting time signal from the receiver and configured to have packet broadcast events that occur respectively aligned with the other signal relay stations at a plurality of times (as shown by the dashed lines at times T1, T2, and T3 in FIG. 7) according to the correcting time signal so as to broadcast the to-be-broadcast data during the act period 502. The transmitter broadcasts the to-be-broadcast data during the act period 502 by using different frequency hopping between the signal relay station and the other signal relay station.

In some embodiments, the transmitter is configured to broadcast a plurality of packets of the to-be-broadcast data by using different frequency hopping sequences. For example, in FIG. 6, different frequency hopping sequences include groups 504, 505, and 506. The frequency hopping sequence of group 504 is channels CH0, CH1, CH2, CH0, CH1, CH2, the frequency hopping sequence of group 505 is channels CH1, CH2, CH0, CH1, CH2, CH0, and the frequency hopping sequence of group 506 is channels CH2, CH0, CH1, CH2, CH0, CH1. In some other embodiments, the transmitter may be configured to broadcast a plurality of packets of the to-be-broadcast data by using the same frequency hopping sequence. For example, the frequency hopping sequences all are channels CH0, CH1, CH2, CH0, CH1, CH2. Additionally, a frequency set used for receiving to-be-broadcast data is different from a frequency set used for broadcasting the to-be-broadcast data. The transmitter may change broadcast frequency for each packet broadcast event.

As shown in FIG. 7, the time at which the receiver starts to receive the to-be-broadcast data is aligned with a time at which other signal relay stations start to broadcast the to-be-broadcast data, and the time at which the transmitter starts to broadcast the to-be-broadcast data is aligned with a time at which other signal relay stations start to receive the to-be-broadcast data. The act period 501 of each signal relay station 1-4 occurs sequentially in time without overlapping. For example, the upper-level device (main transmitting device) can establish communication connections with each signal relay station 1-4 by sequential scanning; the act period 502 of each signal relay station 1-4 also occurs sequentially in time.

Therefore, the transmitter of the signal relay station can receive the correcting time signal from the receiver to ensure that for each signal relay station during the act period 502, each packet broadcast event at each signal relay station occurs simultaneously. Additionally, by using different frequency hopping for each signal relay station, an effect of synchronous frequency division duplex (FDD) is achieved, allowing each signal relay station to transmit packets simultaneously but on different frequencies, thus avoiding interference between packets. The frequency sets used during periods 501 and 502 can be different, and the two sets do not include same frequency to avoid mutual interference.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A transmitting device for a group processing for at least one receiving device within a venue, comprising:
a transmitter configured to transmit a group formation command; and
a command coverage area being an area within the venue where commands transmitted by the transmitter can be received, wherein the command coverage area decides an operation range of a group member in the venue, wherein the group formation command enables the at least one receiving device within the command coverage area to form and/or be identified as a same group.

2. The transmitting device of claim 1, wherein,
the transmitting device is configured to enter a group definition mode according to a group definition command from a command transmitting device, to enable the transmitter to transmit the group formation command.

3. The transmitting device of claim 2, wherein,
the transmitting device is configured to end the group definition mode according to a command for ending group formation or a group action command from the command transmitting device.

4. The transmitting device of claim 2, wherein,
the transmitting device is configured to transmit a command for ending group formation to the command transmitting device and the at least one receiving device and end the group definition mode.

5. The transmitting device of claim 2, wherein the transmitter rewrites an internally prearranged corresponding action of a group action command from the command transmitting device.

6. The transmitting device of claim 1, wherein the transmitting device autonomously enables the transmitter to transmit the group formation command.

7. The transmitting device of claim 1, wherein the transmitting device is a relay station, broadcast, the transmitter transmits the group formation command by broadcast, the group formation command is a signal, light or sound, the command coverage area enables a leaving one of the at least one receiving device no longer to belong to the same group within the command coverage area, the transmitter is configured to transmit a group action command enabling the at least one device within the command coverage area to perform a corresponding action.

8. A group processing method for a receiving device within a venue, comprising:
at the situation that the receiving device enters a command coverage area of one of a plurality of transmitting devices in the venue, the receiving device receiving a group formation command from the one of the transmitting devices; and
according to the group formation command, the receiving device and another receiving device within the command coverage area forming and/or being identified as a same group,
wherein, the command coverage area of the one of the transmitting devices decides an operation range of a group member in the venue.

9. The method of claim 8, further comprising:
before the receiving device receives the group formation command from the one of the transmitting devices, the receiving device enters a waiting mode for grouping setup according to a group definition command from a command transmitting device to wait for the group formation command; and
after the receiving device leaves the command coverage area of one of the transmitting devices, the receiving device removes its group identification.

10. The method of claim 8, further comprising:
at the receiving device, rewriting an internally prearranged corresponding action of a group action command.

11. The method of claim 8, further comprising:
at the situation that the receiving device enters the command coverage area of one of the transmitting devices in the venue and before the receiving device receives the group formation command from the one of the transmitting devices, the receiving device receives any one signal from any one of the transmitting devices and generates a prompt to represent that it has entered the command coverage area, wherein the prompt comprises sound, light, vibration, message, or instruction; and
after the receiving device leaves the command coverage area of one of the transmitting devices, the receiving device generates a prompt to represent that it has left the command coverage area, wherein the prompt comprises sound, light, vibration, message, or instruction.

12. A group processing system for a venue, comprising:
a plurality of transmitting devices, each comprising:
a transmitter configured to transmit a group formation command; and
a command coverage area being an area within the venue where commands transmitted by the transmitter can be received, wherein the command coverage area decides an operation range of a group member in the venue, wherein the group formation command enables the at least one receiving device within the command coverage area to form and/or be identified as a same group,
wherein the group formation command enables to form and/or be identified a group within the command coverage area which is different from a group of a different receiving device within another command coverage area.

13. The system of claim 12, wherein the system further comprises:
a command transmitting device configured to transmit a group definition command to the transmitting devices and the at least one receiving device, enabling the transmitting devices to enter a group definition mode to transmit the group formation command by the transmitter, and enabling the at least one receiving device to enter a waiting mode for grouping setup to wait for the group formation command.

14. The system of claim 13, wherein,
the command transmitting device is configured to transmit a command for ending group formation or a group action command to the transmitting devices and the at least one receiving device, enabling the transmitting devices end the group definition mode and the at least one receiving device ends the waiting mode for grouping setup; or
the transmitting devices are configured to respectively transmit a command for ending group formation to the command transmitting device and the at least one receiving device, enabling the transmitting devices end the group definition mode and the at least one receiving device ends the waiting mode for grouping setup.

15. The system of claim 12, wherein the command transmitting device is configured to transmit a group action command and send the group action command through the transmitting devices to the at least one receiving device, wherein the group action command enables the at least one receiving device within the command coverage area to perform a corresponding action.

16. The system of claim 15, wherein,
the group action command is a specific arranged command or a prearranged corresponding command,
the specific arranged command is with respect to same group to perform same action, and
the prearranged corresponding command is with respect to same group using same identifier to perform same or different action, and is with respect to different groups to perform same or different actions.

17. The system of claim 15, wherein,
the transmitter rewrites an internally prearranged corresponding action of a group action command from the command transmitting device.

18. The system of claim 12, wherein the transmitting devices autonomously enable each transmitter to transmit the group formation command.

19. The system of claim 12, wherein,
the command transmitting device is configured to transmit a command with respect to single one of the transmitting devices, or a single group, or multiple groups,
one of the transmitting devices transmits the command to a single receiving device or a single group or multiple groups according to the command transmitting device.

20. The system of claim 12, wherein,
the command transmitting device rewrites an action corresponding to a internally prearranged command in the receiving device; or
the command transmitting device rewrites an action corresponding to a internally prearranged command with respect to a single receiving device or a single group or multiple groups.
